(19) United States
(12) Patent Application Publication
(10) Pub. No.: US 2010/0027065 A1
(43) Pub. Date: Feb. 4, 2010

(54) PRINTING DEVICE, CONTROL METHOD FOR A PRINTING DEVICE, AND A CONTROL PROGRAM

(75) Inventor: Naohiko Koakutsu, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/511,277

(22) Filed: Jul. 29, 2009

(30) Foreign Application Priority Data
Jul. 29, 2008 (JP) 2008-194815
May 29, 2009 (JP) 2009-130458

(51) Int. Cl. G06F 3/12

(52) U.S. Cl. 358/1.15

(57) ABSTRACT

Without needing reserve printers of plural different types in preparation for an equipment failure, printing as desired can be quickly resumed by simply connecting a replacement printer. The printer 14 has two connection terminals enabling connecting to an external host computer 11 using a daisy chain connection, determines if an external device such as a host computer 11 or another printer 17 is connected to the connection terminals, and based on the result of said determination selects and prints from among specific plural types of print data output from the host computer through the daisy chain connection the print data of the type previously correlated to the connection status of the connection terminal.

### CROSS-REFERENCES TO RELATED APPLICATIONS

This application claims priority to Japanese Patent Application No. 2008-194815, filed Jul. 29, 2008 and Japanese Patent Application No. 2009-130458, filed May 29, 2009. The entirety of both applications are incorporated by reference herein.

### BACKGROUND OF THE INVENTION

1. Technical Field

The present invention relates to a printing device and to a control method for a printing device. A printing device is connected in a daisy chain to a host computer and prints specific print data, and a control method and a control program for the printing device are disclosed.

2. Related Art

Point-of-sale systems (POS system) are commonly used in retail stores, for example, for sales and inventory management. See, for example, Japanese Patent Appl. Pub. No. JP-A-2003-317152. In some POS systems two printers are connected in a daisy chain to the host computer. Receipt paper for printing receipts is loaded as the printing paper in one printer and coupon paper for printing coupons is loaded in the other printer. When configuring this type of system, it is necessary to pre-set each daisy chained printer to either print receipts or print coupons. One way of accomplishing this requires preparing a dedicated printer for each type of print data. Another way of accomplishing this uses identical printers, but requires telling each printer what kind of print data to print by setting a DIP switch, for example.

Users of POS systems, as described above, need to have a spare printer on reserve in case any one of the printers fails. In addition to being expensive, there are other problems in methods used above. For example, one problem is that users with large POS systems need to have a large amount of storage space to store the spare printers. Another problem is that users must identify what kind of print data was printed by the printer that failed, and reset the DIP switch of the replacement printer accordingly. This is tedious and time-consuming.

Therefore, a printing system and method that allows a formation of daisy chain without the above described problems is desired.

### SUMMARY

To solve the foregoing problem, a printing device, a control method and a control program for a printing device are disclosed. Embodiments of the invention enable printing as desired, by simply connecting a printer, and thus eliminating the need to have ready a plurality of different types of printers in preparation for a printer failure.

An embodiment of the invention is directed to a printing device having two connection terminals that enable a connection to an external host computer system and a connection to another printing device using a daisy chain connection, and determine if an external device such as the host device or another printing device is connected to the connection terminals. Based on the type of device, the printing device selects and prints from plural types of print data outputted from the host computer through the daisy chain connection.

Another embodiment is directed toward the ability of the printing device to be switched with another printing device of the same type through the daisy chain, therefore allowing one type of printing device for different types of print data.

Another embodiment is directed to the ability of printing device to determine the type of the external devices connected to the printing device based on the connection status of the connection terminals of the printing device.

Another embodiment is directed to selecting a print data from a plurality of print data received from the host computer system based on the signal level of the signal line in the first and the second connection terminal of the printing device.

Another embodiment is directed to the ability of the printing device to print one of a receipt and coupon from the print data based on its position in the daisy chain, and send the print data to another printing device where the other printing device prints the other of the receipt and coupon from the print data.

Another embodiment is directed to the ability of the printing device to print both the receipt and the coupon from the print data when another printer in the daisy chain malfunctions.

Another embodiment is directed to notifying the host computer system when any one of the printing devices in the daisy chain malfunctions. The host computer is also capable of detecting a printing device that does not function.

Another embodiment is directed to a method for controlling the printing device, the method comprising determining a type of the one or more external devices coupled to the printing device; selecting a print data from a plurality of print data send by one of the one or more external devices, and printing the print data.

### BRIEF DESCRIPTION OF THE DRAWINGS

FIG. 1 is a schematic block diagram of a POS printing system according to an embodiment of the invention.

FIG. 2 describes the connection signal lines according to an embodiment of the invention.

FIG. 3 describes printing a receipt according to an embodiment of the invention.

FIG. 4 describes printing a coupon according to an embodiment of the invention.

FIG. 5 is a flow chart describing operation of the printing device according to an embodiment of the invention.

### DETAILED DESCRIPTION

Embodiments of the present invention are described below with reference to the accompanying figures.

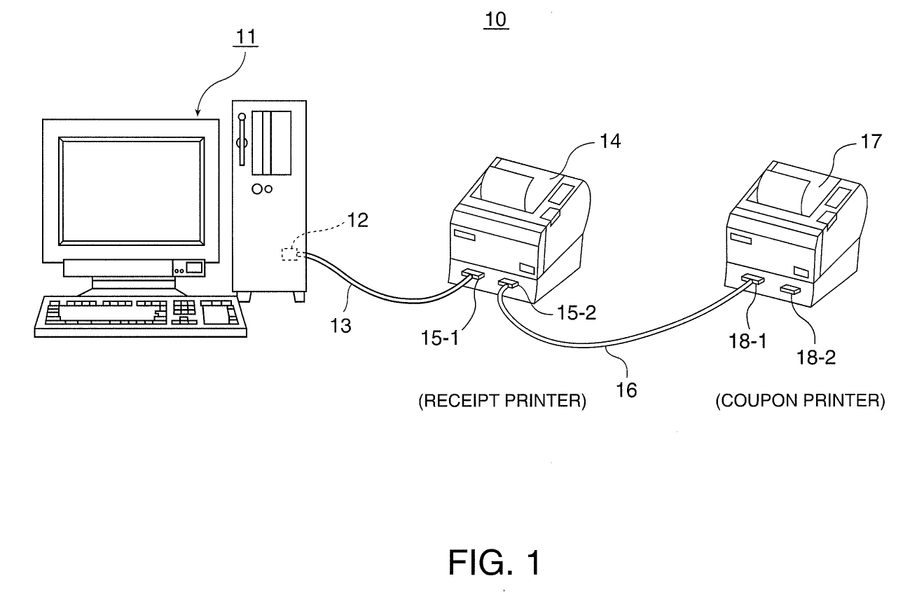

FIG. 1 is a schematic block diagram of a POS printing system according to an embodiment of the invention. This POS printing system 10 includes a host computer 11, and a first serial interface connector 15-1 (connection terminal) of a first printer 14 that is connected through a connector cable 13 to the serial interface connector 12 of the host computer 11. Note that the serial interface connector 12 of the host computer 11 is connected and terminated by a terminating resistance (not shown) inside the host computer 11. The first serial interface connector 18-1 (connection terminal) of a second printer 17 is connected through another connection cable 16 (cross connection cable) to a second serial interface connector 15-2 (connection terminal) of the first printer 14. The second serial interface connector 18-2 (connection terminal) of the second printer 17 is not used in this configuration, and is connected to and terminated by a terminating resistance (not shown) inside the second printer 17. The first printer 14 and the second printer 17 are printers of the same type in this configuration.

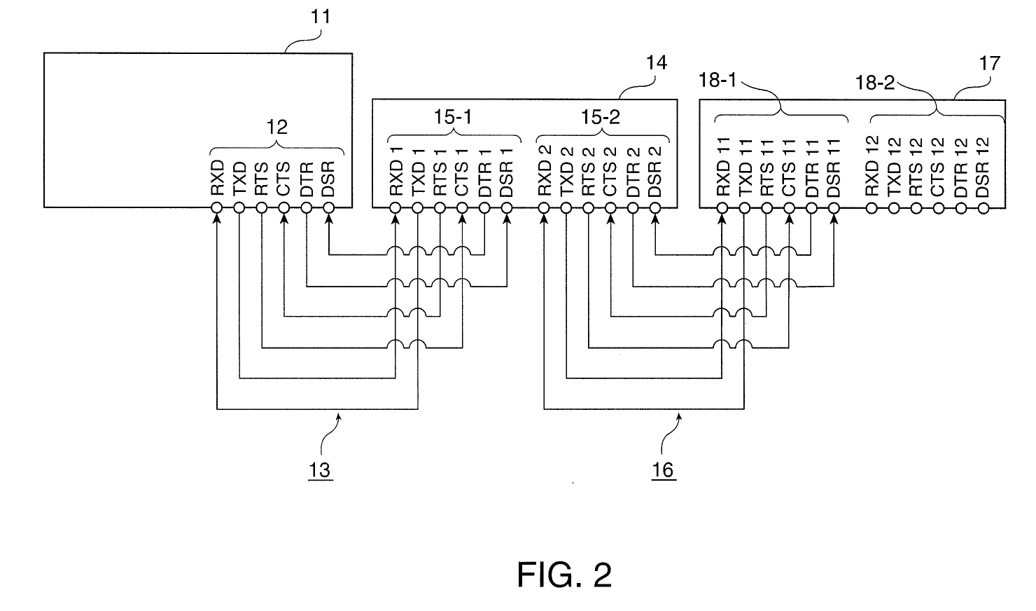

As shown in FIG. 2, the serial interface connector 12 of the host computer 11 has an RXD (Receive Data) line, a TXD (Transmit Data) line, an RTS (Request To Send) line, a CTS (Clear To Send) line, a DTR (Data Terminal Ready) line, and a DSR (Data Set Ready) line.

The first serial interface connector 15-1 of the first printer 14 has a RXD line RXD1, TXD line TXD1, RTS line RTS1, CTS line CTS1, DTR line DTR1, and DSR line DSR1. The second serial interface connector 15-2 of the first printer 14 has a RXD line RXD2, TXD line TXD2, RTS line RTS2, CTS line CTS2, DTR line DTR2, and DSR line DSR2.

Likewise, the first serial interface connector 18-1 of the second printer 17 has a RXD line RXD11, TXD line TXD11, RTS line RTS11, CTS line CTS11, DTR line DTR11, and DSR line DSR11. In addition, the second serial interface connector 18-2 of the first printer 14 has a RXD line RXD12, TXD line TXD12, RTS line RTS12, CTS line CTS12, DTR line DTR12, and DSR line DSR12.

As shown in FIG. 2, each RXD line is connected to a TXD line, each RTS line is connected to a CTS line, and each DTR line is connected to a DSR line so that the overall signal bus is connected in a ring according to the direction of signal flow, that is, in a daisy chain.

In one embodiment, the printer (host printer) that has a device (the host computer 11 and another printer) connected to both the first serial interface connector and the second serial interface connector, operates as a receipt printer for printing receipts. The printer (subordinate printer) that has a printer connected to either its first serial interface connector or second serial interface connector operates as a coupon printer for printing coupons.

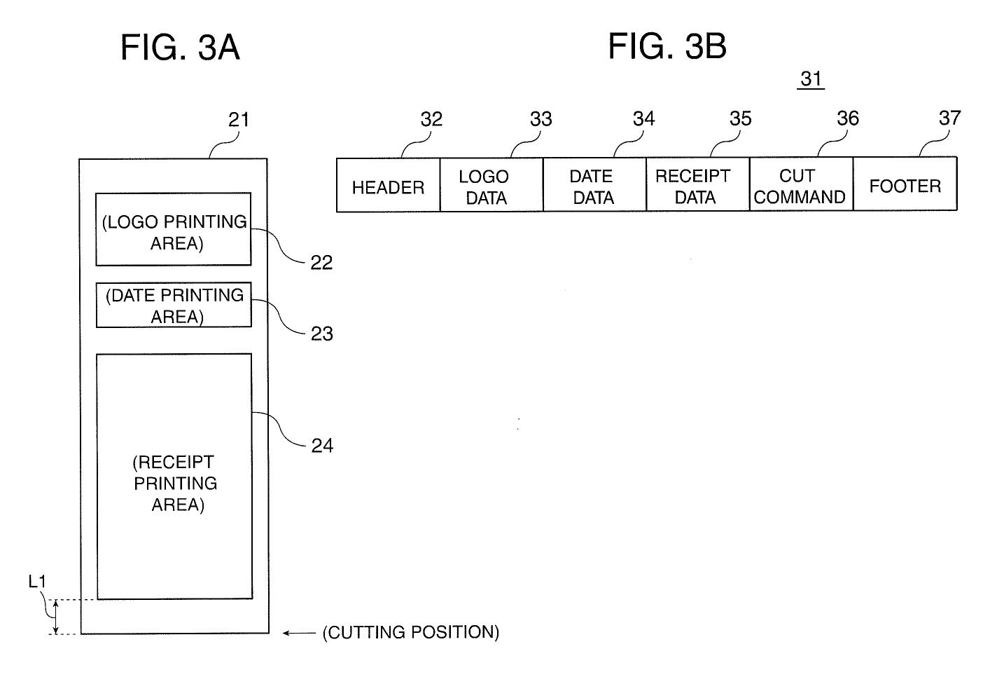

FIG. 3A shows a sample printout of a receipt. The receipt 21 has a logo printing area 22 for printing a logo of the store using the POS printing system 10, a date printing area 23 for printing the date the receipt was issued, and a receipt printing area 24 where the name, price, quantity, and other information about the purchased products is displayed. The first printer 14, according to an embodiment of the invention, also has an automatic paper cutter, which automatically cuts each receipt at a specific distance L1 from the end of the receipt printing area, 24 as shown in FIG. 3A.

FIG. 3B shows the print data for printing a receipt. The receipt printing data 31 includes a header 32 denoting the beginning of the data, logo data 33 for printing a logo in the logo printing area 22, date data 34 denoting the date the receipt is printed, receipt data 35 for printing and displaying the name, price, quantity, and other information about the purchased products in the receipt printing area 24, a cut command 36 for cutting the receipt printing paper, which is roll paper, at a specific cutting position, and a footer 37 denoting the end of the data.

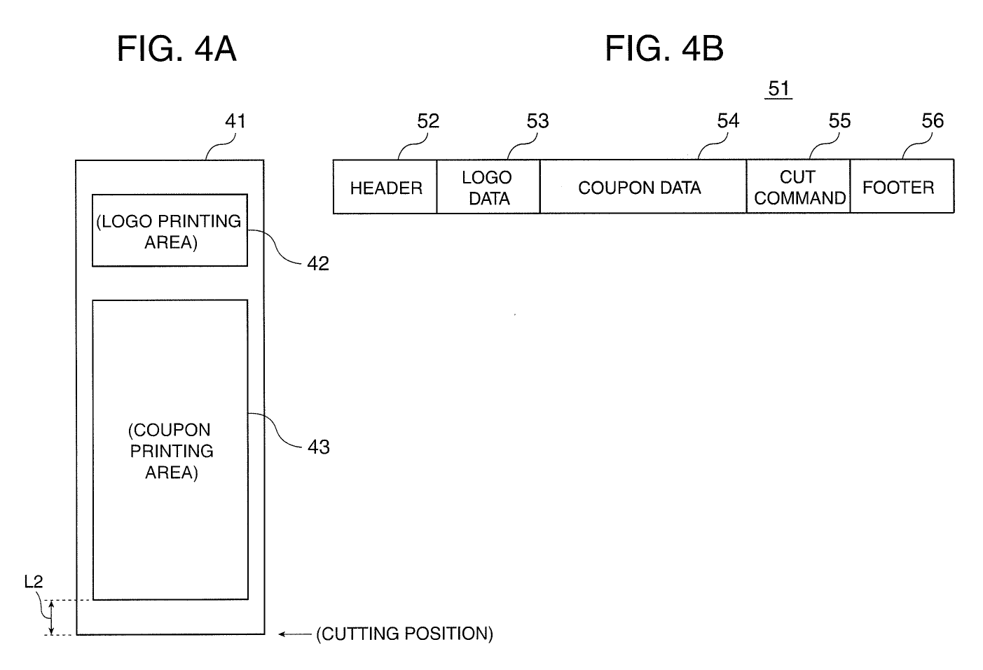

FIG. 4A shows a sample printout of a coupon. The coupon 41 has a logo printing area 42 for printing a logo of the store that uses the POS printing system 10, and a coupon printing area 43 for printing different coupons. The second printer 17 according to this embodiment of the invention also has an automatic paper cutter, and automatically cuts each coupon at a specific distance L2 from the end of the coupon printing area 43 as shown in FIG. 4A.

FIG. 4B describes the print data for printing coupons. The coupon printing data 51 in this embodiment of the invention differs from the receipt printing data 31 in that the date data does not follow the logo data, and if printing the date is required, the date is included in the coupon data.

The coupon printing data 51 includes a header 52 denoting the beginning of the data, logo data 53 for printing a logo in the logo printing area 42, coupon data 54 for printing and displaying the coupons, a cut command 55 for cutting the coupon printing paper, which is roll paper, at a specific cutting position, and a footer 56 denoting the end of the data. In order to prevent forgeries or to impart a sense of quality, the coupon printing paper in an embodiment of the invention may be thicker, higher quality paper than the receipt printing paper, or special paper bearing a hologram, for example.

The timing when the receipt printing data 31 and coupon printing data 51 are sent from the host computer 11 to the first printer 14 or second printer 17 is not specifically defined, and may vary in many ways according to the situation of the store using the POS printing system 10. As a result, the first printer 14 and second printer 17 are always ready to print whenever data is sent as long as the printer power is turned on.

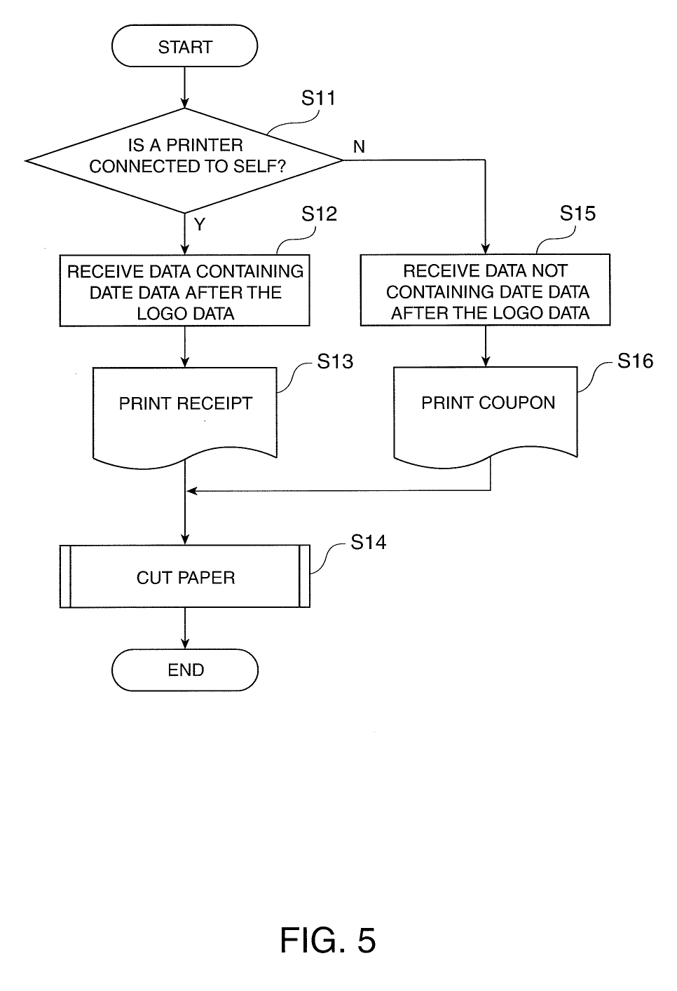

FIG. 5 is a flow chart of the operating process. The steps in this process are executed by a controller such as a microprocessor incorporated in the first printer 14 and second printer 17 executing a firmware.

The controller of the first printer 14 automatically determines if a printer is also connected thereto in addition to the host computer 11, that is, if an external device (host computer or printer) is connected to each of the two connection terminals (step S11, connection status determination unit). More specifically, the controller of the first printer 14 determines if any of the signal lines including RXD line RXD1, TXD line TXD1, RTS line RTS1, CTS line CTS1, DTR line DTR1, and DSR line DSR1 in the first serial interface connector 15-1 (its own serial interface connector) are HIGH. This is because if a device is connected to the first serial interface connector 15-1, one of the pins will be HIGH. If any of the signal lines including RXD line RXD1, TXD line TXD1, RTS line RTS1, CTS line CTS1, DTR line DTR1, and DSR line DSR1 are HIGH, the controller determines that a device is connected to the first serial interface connector 15-1.

The controller of the first printer 14 then determines if any of the signal lines including RXD line RXD2, TXD line TXD2, RTS line RTS2, CTS line CTS2, DTR line DTR2, and DSR line DSR2 in the second serial interface connector 15-2 (its own serial interface connector) are HIGH. If any of the signal lines including RXD line RXD2, TXD line TXD2, RTS line RTS2, CTS line CTS2, DTR line DTR2, and DSR line DSR2 are HIGH, the controller determines that a device is connected to the second serial interface connector 15-2.

If a device is connected to both the first serial interface connector 15-1 and second serial interface connector 15-2, the controller of the first printer 14 determines that the host computer 11 is connected to one connector and a printer is connected to the other connector, and therefore determines in step S11 that there is a second printer (step S11 returns Yes). As a result, the first printer 14 recognizes that it must function as a receipt printer.

Therefore, when print data (receipt printing data 31 or coupon printing data 51) is sent from either the first serial interface connector 15-1 or second serial interface connector 15-2, the controller of the first printer 14 receives print data containing the date data after the logo data. In other words, printer 14 receives the receipt printing data 31 (step S 12). The controller of the first printer 14 also receives the print data that does not contain the date data after the logo data, that is, printer 14 receives the coupon printing data 51. However, as soon as it determines that the received data is not the receipt printing data 31, transfers the coupon printing data 51 to the second printer 17 and deletes the data.

The controller of the first printer 14 then prints a receipt 21 as shown in FIG. 3A based on the received receipt printing data 31 (step S13), cuts the receipt printing paper at the specified cutting position based on the received cut command 36 (step S14), and then ends the process. The controller of the first printer 14 thus selects the data to be printed and the data to be sent to the second printer 17 from the received print data.

The controller of the second printer 17 automatically determines if a printer is connected thereto in addition to the host computer 11, that is, if an external device (host computer or printer) is connected to each of the two connection terminals (step S11). More specifically, the controller of the second printer 17 determines if any of the signal lines including RXD line RXD11, TXD line TXD11, RTS line RTS11, CTS line CTS11, DTR line DTR11, and DSR line DSR11 in the first serial interface connector 18-1 (its own serial interface connector) are HIGH. This is because if a device is connected to the first serial interface connector 18-1, one of the pins will be HIGH.

If any of the signal lines including RXD line RXD11, TXD line TXD11, RTS line RTS11, CTS line CTS11, DTR line DTR11, and DSR line DSR11 are HIGH, the controller determines that a device is connected to the first serial interface connector 18-1.

The controller of the second printer 17 then determines if any of the signal lines including RXD line RXD12, TXD line TXD12, RTS line RTS12, CTS line CTS12, DTR line DTR12, and DSR line DSR12 in the second serial interface connector 18-2 (its own serial interface connector) are HIGH. If any of the signal lines including RXD line RXD12, TXD line TXD12, RTS line RTS12, CTS line CTS12, DTR line DTR12, and DSR line DSR12 are HIGH, the controller determines that a device is connected to the second serial interface connector 18-2. When the system is configured as shown in FIG. 1, a termination resistance is internally connected to the second serial interface connector 18-2, and all signal buses are therefore LOW.

Therefore, if the controller of the second printer 17 determines that a device is only connected to the first serial interface connector 18-1, it determines in step S11 that a printer is not connected downstream therefrom (step S11 returns No). As a result, the second printer 17 recognizes that it is to function as a coupon printer.

When print data (receipt printing data 31 or coupon printing data 51) is then sent from the upstream device, which is the first printer 14 in this configuration, connected to either the first serial interface connector 18-1 or second serial interface connector 18-2, the controller of the second printer 17 receives the print data that does not contain date data after the logo data, that is, receives the coupon printing data 51 (step S15). The controller of the second printer 17 also receives the print data containing the date data after the logo data (the receipt printing data 31), but discards the data as soon as it determines that the received data is not the coupon printing data 51. Note that instead of discarding this data, the print data may also be printed on the second printer 17 as controlled by the controller of the second printer 17.

The controller of the second printer 17 then prints a coupon 41 as shown in FIG. 4A based on the received coupon printing data 51 (step S16), cuts the coupon printing paper at the specified position based on the received cut command 36 (step S14), and ends the process. As described above, the controller of the second printer 17 selects the data to be printed by the second printer 17 from the received print data. The controller can also control the printer to prints all of the received print data.

The foregoing description of operation applies when the first printer 14 functioning as a receipt printer and the second printer 17 functioning as a coupon printer are operating normally. If either printer fails, a printer of the same specifications can be simply connected in place of the printer that failed by reconnecting either connection cable 13 or connection cable 16. The replacement printer connected will automatically recognize whether it is the receipt printer or the coupon printer and print accordingly.

If the host device, the first printer 14 in this example, is functioning normally but the subordinate device, the second printer 17 in this example, fails, all print data may be printed by the host device. That is, the first printer 14 in this example prints both receipts and coupons. Alternatively, the first printer 14 may be configured to print only receipts and report to the host computer that coupons cannot be printed. Alternatively, a printer busy status signal or a pre-configured error message could be sent to the host computer using a particular signal line of the interface connector.

If both printers fail at the same time, the two printers can both be replaced with printers of the same specifications and reconnected using the connection cable 13 and connection cable 16. One printer will thus function as a receipt printer, the other printer will function as a coupon printer, and operation can be quickly restored.

As described above, this embodiment of the invention enables each printer to automatically recognize its own connection state and function as a receipt printer or a coupon printer based on how it is connected. Setting DIP switches is therefore not necessary when replacing a printer due to a printer failure. Therefore, the user's job is simplified because only one type of reserve printer is needed in case of a printer failure, and the need of storing printers that are not being used is eliminated.

This embodiment describes a configuration in which one printer is used as a receipt printer and another printer is used as a coupon printer, but if the data format enables identifying what is to be printed, the invention is not limited to these two types of print data and can be used to print many types of print data. For example, a printer 14 that has two connection terminals enabling connecting to an external host computer 11. Using a daisy chain connection determines if an external device such as a host computer 11 or another printer 17 is connected to the connection terminals. The host computer 11 outputs specific plural types of print data through the daisy chain connection, and based on the result of this determination the printer prints the print data of the type correlated to the connection status of the connection terminals.

For example, if there are four types of print data and an external device is connected to both of the connection terminals, the printer is configured to print three of the four types of print data. However, if an external device is connected to only one of the connection terminals, the printer is configured to print the remaining one of the four types of print data. As a result, one printer 14 having a host computer 11 and another printer 17 connected as external devices to both of its connection terminals can print three of the four types of print data. The other printer 17, which has the one printer 14 connected to one of its connection terminals as an external device, prints the remaining one of four types of print data.

Note that a configuration connecting the second printer 17 to the second serial interface connector 15-2 of the first printer 14 is described above, but because the first serial interface connector 15-1 (18-1) and second serial interface connector 15-2 (18-2) are symmetrical, the same function can be achieved regardless of which connectors the host computer 11 or other printer are connected to.

The controller of the printer 14 used as the higher level device in the foregoing embodiment receives print data that is not addressed to the printer 14 (that is, coupon print data), and controls sending the print data to the printer 17 connected as the subordinate device, upon determining that the received print data is not intended for the first printer 14. If a bus type daisy chain connection such as a SCSI bus is used, print data that is not addressed to particular printer (such as the coupon printing data) may be simply deleted upon determining that the received print data is intended for another printer.

It will be understood that it may be varied in many ways. Such variations are not to be regarded as a departure from the spirit and scope of the invention, and all such modifications as would be understood by one skilled in the art are intended to be included within the scope of the following claims.

What is claimed is:

1. A printing device comprising:
a first and a second connection terminal configured to couple the printing device with one or more external devices;
wherein the printing device is configured to determine a type of the one or more external devices, and further configured to select and print from a plurality of print data sent by the one or more external devices.

2. The printing device of claim 1, wherein the first and the second connection terminals enable a daisy chain connection with an external device.

3. The printing device of claim 1, wherein the printing device is configured to determine the type of the one or more external devices based on the connection status of the one or more external devices to the first and the second connection terminal.

4. The printing device of claim 3, wherein the one or more external devices comprise a host computer system and a second printing device.

5. The printing device of claim 1, wherein the printing device is configured to select a print data from the plurality of print data based on a signal level of a signal line in each of the first and the second connection terminal.

6. The printing device of claim 5, wherein the type of the plurality of print data comprise a receipt printing data and a coupon printing data.

7. The printing device of claim 1, wherein the plurality of print data comprise a receipt printing data and a coupon printing data, and
wherein the printing device is configured to function as a coupon printer and a receipt printer.

8. The printing device of claim 1, wherein the printing device further comprises a connection status determination unit configured to detect when the one or more external devices are connected to the printing device based on a signal level of a signal line in each of the first and the second connection terminal.

9. The printing device of claim 1, wherein when two external devices are coupled to the printing device, the printing device is configured to function as a receipt printer, and
wherein when only one external device is coupled to the printing device, the printing device is configured to function as a coupon printer or a receipt printer or both.

10. The printing device of claim 1, wherein the printing device is configured to receive the plurality of the print data from the first connection terminal, and is configured to select one of the plurality of print data to print and is further configured to send a remaining print data from the plurality of the print data to another printer coupled to the printing device via the second connection terminal.

11. A system comprising:
a first printing device, the first printing device comprising a first and a second connection terminal;
a second printing device, the second printing device comprising a first and a second connection terminal, and
a host computer system coupled to the first printing device via the first connection terminal of the first printing device, wherein the host computer system is configured to output a plurality of print data to the first printing device, and wherein the first printing device and the second printing device are printing devices of the a same type.

12. The system of claim 11, wherein the host computer system is configured to detect when any one of the first printing device or the second printing device does not function.

13. The system of claim 11, wherein the coupling of the host computer system to the first printing device, and the first printing device to the second printing device forms a daisy chain.

14. The system of claim 11, wherein each of the first printing device and the second printing device is configured to detect a type of device coupled to the first and the second connection terminal.

15. The system of claim 11, wherein the first printing device is configured to be placed as the second printing device, and the second printing device is configured to be placed as the first printing device.

16. The system of claim 11, wherein each of the first printing device and the second printing device is configured to print from at least two type of print data comprising a receipt print data and a coupon print data.

17. The system of claim 16, wherein the receipt print data and the coupon print data are sent from the host computer system.

18. The system of claim 17, wherein the first printing device is configured to receive the receipt print data and the coupon print data, select the receipt print data and send the coupon print data to the second printing device.

19. The system of claim 18, wherein when the second printing device does not function, the first printing device is configured to print the receipt print data and the coupon print data.

20. The system of claim 18, wherein when the second printing device does not function, the first printing device is configured to send an error message to the host computer system.

21. A method for controlling a printing device having a first and a second connection terminal configured to couple the printing device with one or more external devices, the method comprising:
determining a type of the one or more external devices coupled to the printing device;
selecting a print data from a plurality of print data send by one of the one or more external devices, and
printing the print data.

22. The method of claim 21, wherein the method of controlling the printing device is performed by a controller, housed in the printing device, using a control program in form of a firmware application.

23. The method of claim 21, wherein the printing device is configured to select a print data from the plurality of print data based on a signal level of a signal line in each of the first and the second connection terminal.

24. The method of claim 21, wherein the type of the plurality of print data comprise a receipt printing data and a coupon printing data.

25. The method of claim 21, wherein the type of the one or more external devices comprise a host computer system and a second printing device.

26. A method for controlling a printing system that comprises:
a first printing device, the first printing device comprising a first and a second connection terminal;
a second printing device, the second printing device comprising a first and a second connection terminal, and
a host computer system coupled to the first printing device via the first connection terminal of the first printing device, wherein the host computer system is configured to output a plurality of print data to the first printing device,
the method comprising:
determining, in the first printing device, that the host computer system is coupled to the first connection terminal and the second printing device is coupled to the second connection terminal;
selecting, in the first printing device, a print receipt data from the plurality of print data;
printing, in the first printing device, a receipt from the print receipt data, and
sending the plurality of print data from the first printing device to the second printing device.

27. The method of claim 26, further comprising:
determining, in the second printing device, that the first printing device is coupled to the first connection terminal and no external device is coupled to the second connection device;
selecting, in the second printing device, a coupon print data from the plurality of print data, and
printing, in the second printing device, a coupon from the print coupon data.
